(19) United States
(12) Patent Application Publication
(10) Pub. No.: US 2016/0139447 A1
(43) Pub. Date: May 19, 2016

(54) TRANSPARENT LIQUID CRYSTAL DISPLAY DEVICE

(71) Applicant: SHENZHEN CHINA STAR OPTOELECTRONICS TECHNOLOGY CO., LTD., Shenzhen, Guangdong (CN)

(72) Inventors: Yu-Chun Hsiao, Shenzhen, Guangdong (CN); Shih Hsiang Chen, Shenzhen, Guangdong (CN); Guofu Tang, Shenzhen, Guangdong (CN); Quan Li, Shenzhen, Guangdong (CN); Chengling Lv, Shenzhen, Guangdong (CN); Chaofan Guo, Shenzhen, Guangdong (CN)

(21) Appl. No.: 14/417,662

(22) PCT Filed: Nov. 18, 2014
(86) PCT No.: PCT/CN2014/091429

§ 371 Date: Jan. 27, 2015

(30) Foreign Application Priority Data
Nov. 14, 2014 (CN) 201410647779.6

(51) Int. Cl. G02F 1/1347; G02F 1/1343; G02F 1/1333

(52) U.S. Cl. CPC G02F 1/13471; G02F 1/13338; G02F 1/13439; G02F 1/134309

(57) ABSTRACT

A transparent liquid crystal display device is provided including a transparent liquid crystal cell disposed on a transparent luminous plate. The transparent luminous plate includes a first transparent electrode plate, phosphor layer, and an electron-generating plate, which are sequentially disposed on a second transparent electrode plate. Since the liquid crystal cell and the luminous plate are transparent, a viewer can not only see an image to be displayed by a screen of the display panel, but can also see an object or a scene behind the display panel through the screen.

### FIELD OF THE INVENTION

The present invention relates to a field of display technology, and particularly to a transparent liquid crystal display device.

### BACKGROUND OF THE INVENTION

In the prior art, conventional display device is usually non-transparent. For example, conventional display device is usually provided with a backlight module for providing light to a liquid crystal cell, so that light passes through a corresponding pixel unit of the liquid crystal cell, thereby displaying an image. Since the backlight module is non-transparent, a viewer cannot see an object or a scene behind the display panel through a screen of the display panel. Therefore, the conventional display devices are non-transparent.

Although an OLED display technology has emerged, the back surface of a conventional OLED is provided with a metal plate which is also non-transparent for reflecting light. Since the metal plate is disposed on a back surface of a display panel, a viewer also cannot see an object or a scene behind the display panel through a screen of the display panel. Therefore, the conventional OLEDs are non-transparent.

Therefore, it is necessary to provide a transparent display panel where an image to be displayed can be shown by a screen of a display panel, also an object or a scene behind the display panel can be seen through the screen.

Accordingly, it is necessary to provide a new technical solution to solve the above technical problems.

### SUMMARY OF THE INVENTION

An object of the present invention is to provide a transparent liquid crystal display device, where an image to be displayed can be shown by a screen of a display panel, also an object or a scene behind the display panel can be seen through the screen.

In order to solve the above-mentioned problem, the technical solution of the present invention is as follows:

A transparent liquid crystal display device comprises a transparent touch display panel, a transparent liquid crystal cell, and a transparent luminous plate, where the transparent touch display panel and the transparent liquid crystal cell are sequentially disposed on the transparent luminous plate.

The transparent luminous plate comprises a first transparent electrode plate, a phosphor layer, an electron-generating plate, and a second transparent electrode plate. The first transparent electrode plate, the phosphor layer, and the electron-generating plate are sequentially disposed on the second transparent electrode plate.

An electron is generated after the electron-generating plate is electrified. The electron is transmitted in a random direction. An electric field E is formed after the first transparent electrode plate and the second transparent electrode plate are electrified. The electric field E induces the electron which is generated by the electron-generating plate move toward to the phosphor layer. After the phosphor layer is hit by the electron, the phosphor layer emits light, which is provided to the transparent liquid crystal cell.

Preferably, the transparent liquid crystal display device further comprises a controller. The transparent touch display panel, the transparent liquid crystal cell, the first transparent electrode plate, the electron-generating plate, and the second transparent electrode plate are respectively electrical connected with the controller.

Preferably, a plurality of transparent electrodes are spaced apart and disposed on a surface of the electron-generating plate.

Preferably, a plurality of rows of the transparent electrodes are disposed on a surface of the electron-generating plate, each row comprises a plurality of the transparent electrodes. The plurality of the transparent electrodes of each row are arranged to be evenly spaced apart from each other.

Preferably, the transparent electrodes between rows are arranged to be evenly spaced apart from each other. The transparent electrodes at an (N)th row and the transparent electrodes at an (N+1)th row are disposed in a staggered position.

Preferably, the transparent electrode is formed in a protuberant shape.

Preferably, a plurality of comb-like electrode strips are provided on a surface of the electron-generating plate.

Preferably, the comb-like electrode strip comprises a trunk and a plurality of teeth. The plurality of teeth are arranged on a side of the trunk and are evenly spaced apart from each other. The trunk of the comb-like electrode strip at an (N)th row and the trunk of the comb-like electrode strip at an (N+1)th row are arranged in parallel.

Preferably, the teeth of the comb-like electrode strip at the (N)th row and the teeth of the comb-like electrode strip at the (N+1)th row are arranged in a staggered position.

Preferably, the comb-like electrode strip comprises a trunk and a plurality of teeth. The plurality of teeth are arranged on a bottom side of the trunk of the comb-like electrode strip at a first row and are evenly spaced apart from each other. The plurality of teeth are arranged on a top side of the trunk of the comb-like electrode strip at a last row and are evenly spaced apart from each other. The plurality of teeth are arranged on bottom sides and top sides of the trunks of the plurality of comb-like electrode strips between the first row and the last row and are evenly spaced apart from each other. The teeth on a bottom side of the comb-like electrode strip at an (N)th row and the teeth on a top side of the comb-like electrode strip at an (N+1)th row are sequentially arranged in a staggered position.

A transparent liquid crystal display device comprises a transparent liquid crystal cell and a transparent luminous plate, where the transparent liquid crystal cell is disposed on the transparent luminous plate.

The transparent luminous plate comprises a first transparent electrode plate, a phosphor layer, an electron-generating plate, and a second transparent electrode plate. The first transparent electrode plate, the phosphor layer, and the electron-generating plate are sequentially disposed on the second transparent electrode plate.

An electron is generated after the electron-generating plate is electrified. The electron is transmitted in a random direction. An electric field E is formed after the first transparent electrode plate and the second transparent electrode plate are electrified. The electric field E induces the electron which is generated by the electron-generating plate move toward to the phosphor layer. After the phosphor layer is hit by the electron, the phosphor layer emits light, which is provided to the transparent liquid crystal cell.

Preferably, the transparent liquid crystal display device further comprises a controller. The transparent liquid crystal cell, the first transparent electrode plate, the electron-generating plate, and the second transparent electrode plate are respectively electrical connected with the controller.

Preferably, a plurality of transparent electrodes are spaced apart and disposed on a surface of the electron-generating plate.

Preferably, a plurality of rows of the transparent electrodes are disposed on a surface of the electron-generating plate, and each row comprises a plurality of the transparent electrodes. The plurality of the transparent electrodes of each row are arranged to be evenly spaced apart from each other.

Preferably, the transparent electrodes between rows are arranged to be evenly spaced apart from each other. The transparent electrodes at an (N)th row and the transparent electrodes at an (N+1)th row are disposed in a staggered position.

Preferably, the transparent electrode is formed in a protuberant shape.

Preferably, a plurality of comb-like electrode strips are provided on a surface of the electron-generating plate.

Preferably, the comb-like electrode strip comprises a trunk and a plurality of teeth. The plurality of teeth are arranged on a side of the trunk and are evenly spaced apart from each other. The trunk of the comb-like electrode strip at an (N)th row and the trunk of the comb-like electrode strip at an (N+1)th row are arranged in parallel.

Preferably, the teeth of the comb-like electrode strip at the (N)th row and the teeth of the comb-like electrode strip at the (N+1)th row are arranged in a staggered position.

Preferably, the comb-like electrode strip comprises a trunk and a plurality of teeth. The plurality of teeth are arranged on a bottom side of the trunk of the comb-like electrode strip at a first row and are evenly spaced apart from each other. The plurality of teeth are arranged on a top side of the trunk of the comb-like electrode strip at a last row and are evenly spaced apart from each other. The plurality of teeth are arranged on bottom sides and top sides of the trunks of the plurality of comb-like electrode strips between the first row and the last row and are evenly spaced apart from each other. The teeth on a bottom side of the comb-like electrode strip at an (N)th row and the teeth on a top side of the comb-like electrode strip at an (N+1)th row are sequentially arranged in a staggered position.

In comparison to the prior art, a transparent luminous plate is provided by the present invention. The transparent luminous plate comprises a first transparent electrode plate, a phosphor layer, an electron-generating plate, and a second transparent electrode plate. The first transparent electrode plate, the phosphor layer, and the electron-generating plate are sequentially disposed on the second transparent electrode plate. An electron is generated after the electron-generating plate is electrified. The electron is transmitted in a random direction. An electric field E is formed after the first transparent electrode plate and the second transparent electrode plate are electrified. The electric field E induces the electron which is generated by the electron-generating plate move toward to the phosphor layer. After the phosphor layer is hit by the electron, the phosphor layer emits light, which is provided to the transparent liquid crystal cell, so that light passes through a corresponding pixel unit of the liquid crystal cell, thereby displaying an image. Therefore, since the display panel, the liquid crystal cell, and the luminous plate of the present invention are transparent, a viewer can not only see an image to be displayed by a screen of the display panel, but can also see an object or a scene behind the display panel through the screen.

In order to make the present invention more clear, preferred embodiments and the drawings thereof are described in detail below.

### BRIEF DESCRIPTION OF THE DRAWINGS

FIG. 1 shows a schematic diagram of a transparent liquid crystal display device according to a first embodiment of the present invention.

FIG. 2a shows a schematic diagram of a top view of an electron-generating plate according to the first embodiment of the present invention.

FIG. 2b shows another schematic diagram of a top view of an electron-generating plate according to the first embodiment of the present invention.

FIG. 3 shows a section view of the electron-generating plate according to the first embodiment of the present invention.

FIG. 4 shows a schematic diagram of the transparent liquid crystal display device in functional state according to an embodiment of the present invention.

FIG. 5 shows a schematic diagram of a transparent liquid crystal display device according to a second embodiment of the present invention.

FIG. 6 shows a schematic diagram of a top view of an electron-generating plate according to the second embodiment of the present invention.

FIG. 7 shows another schematic diagram of a top view of an electron-generating plate according to the second embodiment of the present invention.

### DETAILED DESCRIPTION OF THE INVENTION

The term “embodiment” is used herein to mean serving as an example, instance, or illustration. In addition, the articles “a” and “an” as used in this application and the appended claims should generally be construed to mean “one or more” unless specified otherwise or clear from the context to be directed to a singular form.

In the embodiments of the present invention, a transparent luminous plate is provided. The transparent luminous plate comprises a first transparent electrode plate, a phosphor layer, an electron-generating plate, and a second transparent electrode plate. The first transparent electrode plate, the phosphor layer, and the electron-generating plate are sequentially disposed on the second transparent electrode plate. An electron is generated after the electron-generating plate is electrified. The electron is transmitted in a random direction. An electric field E is formed after the first transparent electrode plate and the second transparent electrode plate are electrified. The electric field E induces the electron which is generated by the electron-generating plate move toward to the phosphor layer. After the phosphor layer is hit by the electron, the phosphor layer emits light, which is provided to the transparent liquid crystal cell, so that light passes through a corresponding pixel unit of the liquid crystal cell, thereby displaying an image. Therefore, since the display panel, the liquid crystal cell, and the luminous plate of the embodiments of the present invention are transparent, a viewer can not only see an image to be displayed by a screen of the display panel, but can also see an object or a scene behind the display panel through the screen.

### First Embodiment

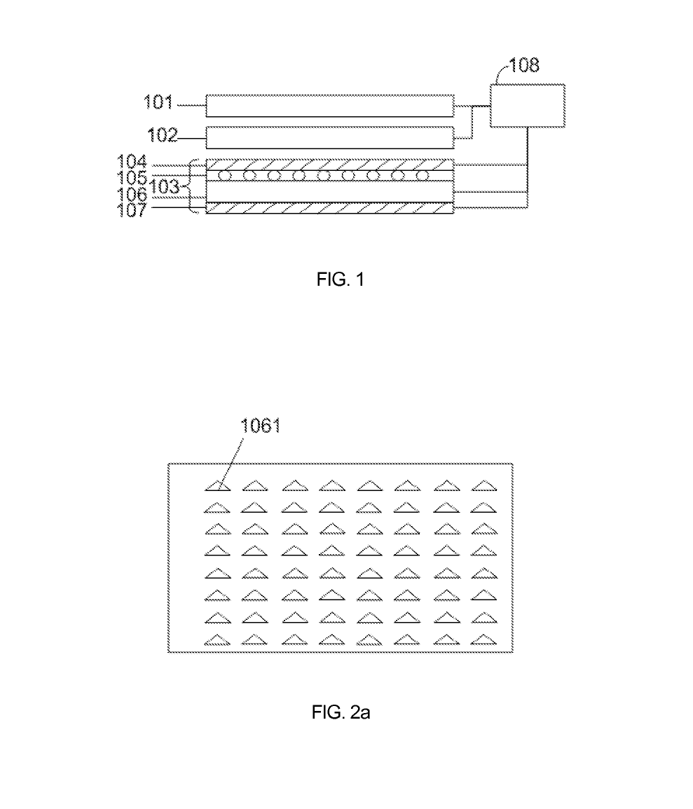

Please refer to FIG. 1, which shows a schematic diagram of a transparent liquid crystal display device according to a first embodiment of the present invention. For ease of description, only a part relevant to the embodiment of the present invention is shown.

The transparent liquid crystal display device comprises a transparent display panel 101, a transparent liquid crystal cell 102, and a transparent luminous plate 103. The transparent display panel 101 is disposed on the transparent liquid crystal cell 102. The transparent liquid crystal cell 102 is disposed on the transparent luminous plate 103. The transparent luminous plate 103 is used for generating light, which is provided to the transparent liquid crystal cell 102, so that light passes through a corresponding pixel unit of the transparent liquid crystal cell 102, thereby displaying an image.

The transparent luminous plate 103 comprises a first transparent electrode plate 104, a phosphor layer 105, an electron-generating plate 106, and a second transparent electrode plate 107. The first transparent electrode plate 104, the phosphor layer 105, and the electron-generating plate 106 are sequentially disposed on the second transparent electrode plate 107.

However, it should be understood that the transparent display panel 101 may be a transparent touch display panel. The transparent display panel 101 is optional. For example, when a transparent liquid crystal display device with a touch function is need, the transparent display panel 101 can be disposed on the transparent liquid crystal cell 102. In another example, if the transparent liquid crystal display device does not need the touch function, the transparent display panel 101 does not need to be included. That is, the transparent display panel 101 is not disposed on the transparent liquid crystal cell 102.

In the embodiment of the present invention, a pair of electron and hole are generated after the electron-generating plate 106 is electrified. The pair of electrons and holes will be transmitted in a random direction (i.e. in all directions). A capacitance is formed after the first transparent electrode plate 104 and the second transparent electrode plate 107 are electrified, and an electric field E is therefore formed between the first transparent electrode plate 104 and the second transparent electrode plate 107. The electric field E will induce the electron which is generated by the electron-generating plate 106 move toward to the phosphor layer 105. After the phosphor layer 105 is hit by the electron, the phosphor layer 105 will emit light, which is provided to the transparent liquid crystal cell 102, so that light passes through a corresponding pixel unit of the liquid crystal cell 102, thereby displaying an image.

In the embodiment of the present invention, the transparent liquid crystal display device further comprises a controller 108. The transparent display panel 101, the transparent liquid crystal cell 102, the first transparent electrode plate 104, the electron-generating plate 106, and the second transparent electrode plate 107 are respectively electrical connected with the controller 108.

However, it should be understood that the controller 108 is used for adjusting the rotation of the liquid crystal of the transparent liquid crystal cell 102. Also, the controller 108 is used for receiving a touch instruction from the transparent display panel 101, and then analyzing the touch instruction. The controller 108 is used for outputting control signals to the first transparent electrode plate 104, the electron-generating plate 106, and the second transparent electrode plate 107.

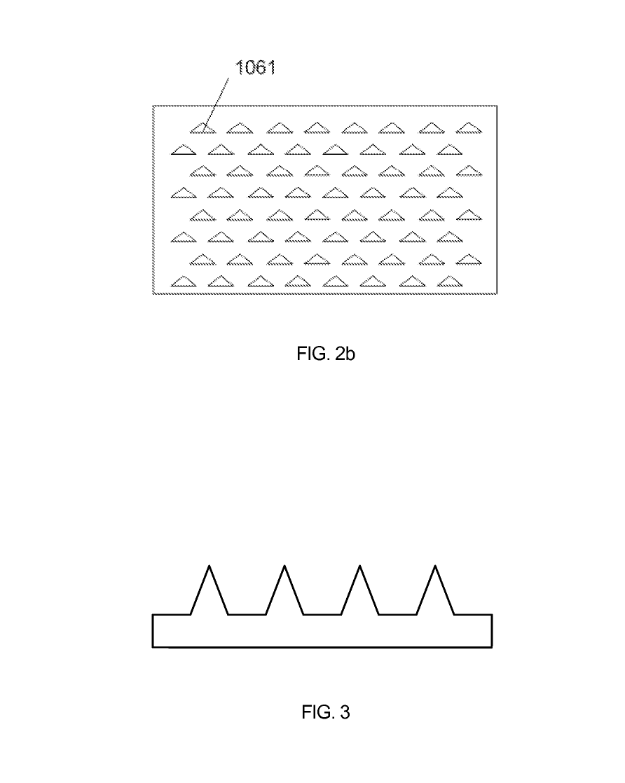

Please refer to FIG. 2a and FIG. 3. FIG. 2a shows a schematic diagram of a top view of an electron-generating plate according to the first embodiment of the present invention. FIG. 2b shows another schematic diagram of a top view of an electron-generating plate according to the first embodiment of the present invention. FIG. 3 shows a section view of the electron-generating plate according to the first embodiment of the present invention.

In the embodiment of the present invention, a plurality of transparent electrodes 1061 are spaced apart and disposed on a surface of the electron-generating plate 106. However, it should be understood that the plurality of transparent electrodes 1061 can be spaced apart from each other at regular intervals and disposed on the surface of the electron-generating plate 106. Alternatively, they can be spaced apart from each other at random intervals and disposed on the surface of the electron-generating plate 1063. The transparent electrode is formed in a protuberant shape, such as tapered, conical, etc., but is not limited to. Any modification, equivalent alteration and modification, etc., made within the spirit and principle of the present invention should be encompassed in the protection scope of the present invention. For example, the transparent electrode is indium tin oxide (ITO).

In the embodiment of the present invention, a tip-shape of the protuberant transparent electrode 1061 can be formed by applying an etching method. However, another method can be applied for making the transparent electrode 1061 to form the protuberant shape. Any modification, equivalent alteration and modification, etc., made within the spirit and principle of the present invention should be encompassed in the protection scope of the present invention.

In a preferable embodiment of the present invention, this is described in greater detail using the example of a plurality of transparent electrodes 1061 being spaced apart from each other at regular intervals and disposed on the surface of the electron-generating plate 106. The plurality of transparent electrodes 1061 are arranged in an array. For example, a plurality of rows of transparent electrodes 1061 are disposed on the surface of the electron-generating plate 106. The transparent electrodes 1061 of each row are arranged to be spaced apart. Each row comprises a plurality transparent electrodes 1061. The transparent electrodes 1061 are arranged to be evenly spaced apart from each other. However, it should be understood that the intervals between rows and the spacing distances between transparent electrodes 1061 may be set as actually required. As shown in FIG. 2a, the transparent electrodes 1061 between rows may be located corresponding to each other.

In another embodiment of the present invention, as shown in FIG. 2b, the transparent electrodes at an (N)th row and the transparent electrodes at an (N+1)th row are disposed in a staggered position. For example, a plurality of rows of transparent electrodes 1061 are disposed on the surface of the electron-generating plate 106. The transparent electrodes 1061 of each row are arranged to be spaced apart. Each row comprises a plurality transparent electrodes 1061. The transparent electrodes 1061 are arranged to be evenly spaced apart from each other. However, it should be understood that the intervals between rows and the spacing distances between transparent electrodes 1061 may be set as actually required. The transparent electrodes between rows are arranged to be evenly spaced apart from each other. The transparent electrodes at the (N)th row and the transparent electrodes at the (N+1)th row are disposed in a staggered position. That is, the transparent electrodes at the (N)th row correspond to the intervals between the transparent electrodes at the (N+1)th row.

In the embodiment of the present invention, after electrifying, a lot of electrons will be collected in a tip portion of the protuberant transparent electrode 1061. Some of the electrons will be squeezed out, thereby achieving the discharge effect.

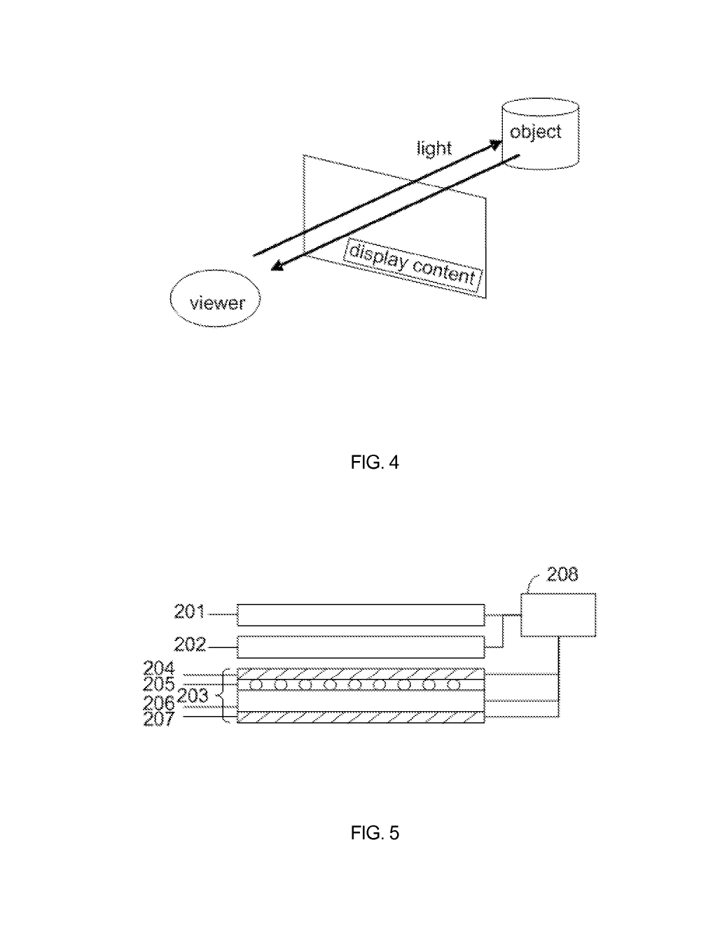

Please refer to FIG. 4, which shows a schematic diagram of the transparent liquid crystal display device in a functional state according to an embodiment of the present invention. An electron is generated after the transparent electrode of the electron-generating plate is electrified. The electron will be transmitted in all directions. An electric field E is formed after the first transparent electrode plate and the second transparent electrode plate are electrified. The electric field E will induce the electron which is generated by the electron-generating plate move toward to the phosphor layer. After the phosphor layer is hit by the electron, the phosphor layer will emit light, which is provided to the transparent liquid crystal cell, so that light passes through a corresponding pixel unit of the liquid crystal cell, thereby displaying an image. A viewer can see an image to be displayed by a screen of the display panel. Since the display panel, the liquid crystal cell, and the luminous plate are transparent, the viewer can see an object or a scene behind the display panel through the screen.

From the above, in the first embodiment of the present invention, the electron is generated after the transparent electrode of the electron-generating plate is electrified. The electron will be transmitted in all directions. One electric field E is formed after the first transparent electrode plate and the second transparent electrode plate are electrified. The electric field E will induce the electron which is generated by the electron-generating plate move toward to the phosphor layer. After the phosphor layer is hit by the electron, the phosphor layer will emit light, which is provided to the transparent liquid crystal cell, so that light passes through a corresponding pixel unit of the liquid crystal cell, thereby displaying an image. Therefore, in the first embodiment of the present invention, since the display panel, the liquid crystal cell, and the luminous plate are transparent, a viewer can not only see an image to be displayed by a screen of the display panel, but can also see an object or a scene behind the display panel through the screen.

### Second Embodiment

Please refer to FIG. 5, which shows a schematic diagram of a transparent liquid crystal display device according to a second embodiment of the present invention. For ease of description, only a part relevant to the embodiment of the present invention is shown.

The transparent liquid crystal display device comprises a transparent display panel 201, a transparent liquid crystal cell 202, and a transparent luminous plate 203. The transparent display panel 201 is disposed on the transparent liquid crystal cell 202. The transparent liquid crystal cell 202 is disposed on the transparent luminous plate 203. The transparent luminous plate 203 is used for generating light, which is provided to the transparent liquid crystal cell 202, so that light passes through a corresponding pixel unit of the transparent liquid crystal cell 202, thereby displaying an image.

The transparent luminous plate 203 comprises a first transparent electrode plate 204, a phosphor layer 205, an electron-generating plate 206, and a second transparent electrode plate 207. The first transparent electrode plate 204, the phosphor layer 205, and the electron-generating plate 206 are sequentially disposed on the second transparent electrode plate 207.

However, it should be understood that the transparent display panel 201 may be a transparent touch display panel. The transparent display panel 201 is optional. For example, when a transparent liquid crystal display device with a touch function is need, the transparent display panel 201 can be disposed on the transparent liquid crystal cell 202. In another example, if the transparent liquid crystal display device does not need the touch function, the transparent display panel 201 does not need to be included. That is, the transparent display panel 201 is not disposed on the transparent liquid crystal cell 202.

In the embodiment of the present invention, a pair of electron and hole are generated after the electron-generating plate 106 is electrified. The pair of electron and hole will be transmitted in a random direction (i.e. in all directions). A capacitance is formed after the first transparent electrode plate 204 and the second transparent electrode plate 207 are electrified, an electric field E is therefore formed between the first transparent electrode plate 204 and the second transparent electrode plate 207. The electric field E will induce the electron which is generated by the electron-generating plate 206 move toward to the phosphor layer 205. After the phosphor layer 205 is hit by the electron, the phosphor layer 205 will emit light, which is provided to the transparent liquid crystal cell 202, so that light passes through a corresponding pixel unit of the liquid crystal cell 202, thereby displaying an image.

In the embodiment of the present invention, the transparent liquid crystal display device further comprises a controller 208. The transparent display panel 201, the transparent liquid crystal cell 202, the first transparent electrode plate 204, the electron-generating plate 206, and the second transparent electrode plate 207 are respectively electrical connected with the controller 208.

However, it should be understood that the controller 208 is used for adjusting the rotation of the liquid crystal of the transparent liquid crystal cell 202. Also, the controller 108 is used for receiving a touch instruction from the transparent display panel 201, and then analyzing the touch instruction. The controller 208 is used for outputting control signals to the first transparent electrode plate 204, the electron-generating plate 206, and the second transparent electrode plate 207.

Please refer to FIG. 6, which shows a schematic diagram of a top view of the electron-generating plate according to the second embodiment of the present invention.

In the embodiment of the present invention, a plurality of comb-like electrode strips 2061 are provided on a surface of the electron-generating plate 206. The comb-like electrode strip may be indium tin oxide (ITO). The plurality of comb-like electrode strips 2061 are arranged in an array. Teeth of the comb-like electrode strip at an (N)th row and teeth of the comb-like electrode strip at an (N+1)th row are sequentially arranged in a staggered position. That is, the comb-like electrode strip 2061 comprises a trunk and a plurality of teeth. The plurality of teeth are arranged on a side of the trunk and are evenly spaced apart from each other. The trunk of the comb-like electrode strip at the (N)th row and the trunk of the comb-like electrode strip at the (N+1)th row are arranged in parallel. The teeth of the comb-like electrode strip at the (N)th row are interposed on intervals between teeth of the comb-like electrode strip at the (N+1)th row.

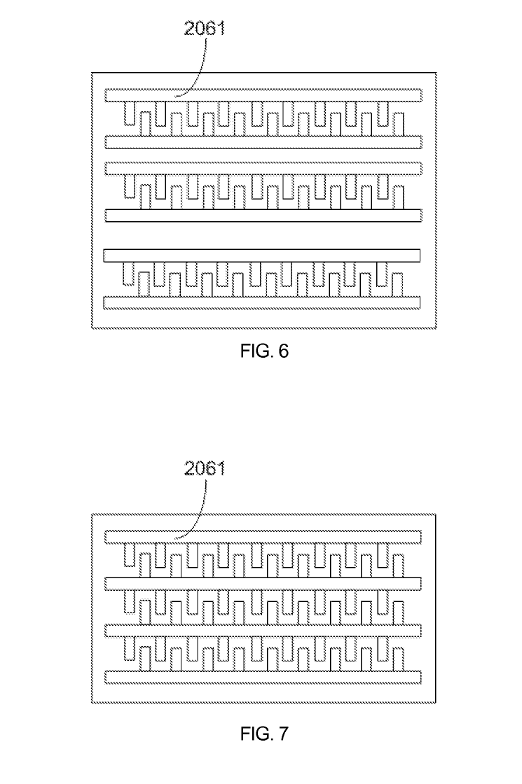

Please refer to FIG. 7, which shows another schematic diagram of a top view of the electron-generating plate according to the second embodiment of the present invention.

A plurality of comb-like electrode strips 2061 are provided on a surface of the electron-generating plate 206. The comb-like electrode strip comprises a trunk and a plurality of teeth. The plurality of teeth are arranged on a bottom side of the trunk of the comb-like electrode strip at a first row and are evenly spaced apart from each other. The plurality of teeth are arranged on a top side of the trunk of the comb-like electrode strip at a last row and are evenly spaced apart from each other. The plurality of teeth are arranged on bottom sides and top sides of the trunks of the plurality of comb-like electrode strips between the first row and the last row and are evenly spaced apart from each other. The teeth on a bottom side of the comb-like electrode strip at an (N)th row and the teeth on a top side of the comb-like electrode strip at an (N+1)th row are sequentially arranged in a staggered position.

For example, the surface of the electron-generating plate 206 is provided with a plurality of comb-like electrode strips, where the teeth are disposed on the lower surface of the comb-like electrode strip at the first row, the teeth are disposed on the upper surface of the comb-like electrode strip at the last row, and the teeth are disposed on the lower surface and the upper surface of the comb-like electrode strips between the first row and the last row. The teeth on the lower surface of the comb-like electrode strip at the (N)th row are interposed on intervals between the teeth on the upper surface of the comb-like electrode strip at the (N+1)th row.

In the embodiment of the present invention, after electrifying, a lot of electrons will be collected in a tip portion of the comb-like electrode strip. Some of the electrons will be squeezed out, thereby achieving the discharge effect.

From the above, in the second embodiment of the present invention, the electron is generated after the tips of the teeth of the comb-like electrode of the electron-generating plate are electrified. The electron will be transmitted in all directions. One electric field E is formed after the first transparent electrode plate and the second transparent electrode plate are electrified. The electric field E will induce the electron which is generated by the electron-generating plate move toward to the phosphor layer. After the phosphor layer is hit by the electron, the phosphor layer will emit light, which is provided to the transparent liquid crystal cell, so that light passes through a corresponding pixel unit of the liquid crystal cell, thereby displaying an image. Therefore, in the second embodiment of the present invention, since the display panel, the liquid crystal cell, and the luminous plate are transparent, a viewer can not only see an image to be displayed by a screen of the display panel, but can also see an object or a scene behind the display panel through the screen.

From the above, in the embodiments of the present invention, transparent liquid crystal display devices are provided with transparent luminous plates. The transparent luminous plate comprises a first transparent electrode plate, a phosphor layer, an electron-generating plate, and a second transparent electrode plate. The first transparent electrode plate, the phosphor layer, and the electron-generating plate are sequentially disposed on the second transparent electrode plate. An electron is generated after the electron-generating plate is electrified. The electron will be transmitted in a random direction. An electric field E is formed after the first transparent electrode plate and the second transparent electrode plate are electrified. The electric field E will induce the electron which is generated by the electron-generating plate move toward to the phosphor layer. After the phosphor layer is hit by the electron, the phosphor layer will emit light, which is provided to the transparent liquid crystal cell, so that light passes through a corresponding pixel unit of the liquid crystal cell, thereby displaying an image. Therefore, in the embodiments of the present invention, since the display panel, the liquid crystal cell, and the luminous plate are transparent, a viewer can not only see an image to be displayed by a screen of the display panel, but can also see an object or a scene behind the display panel through the screen.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular, with regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such a feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The above descriptions are merely preferable embodiments of the present invention, but are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

What is claimed is:

1. A transparent liquid crystal display device, comprising a transparent touch display panel, a transparent liquid crystal cell, and a transparent luminous plate, wherein the transparent touch display panel and the transparent liquid crystal cell are sequentially disposed on the transparent luminous plate;
wherein the transparent luminous plate comprises a first transparent electrode plate, a phosphor layer, an electron-generating plate, and a second transparent electrode plate; the first transparent electrode plate, the phosphor layer, and the electron-generating plate are sequentially disposed on the second transparent electrode plate;
an electron is generated after the electron-generating plate is electrified, the electron is transmitted in a random direction; an electric field E is formed after the first transparent electrode plate and the second transparent electrode plate are electrified; the electric field E induces the electron which is generated by the electron-generating plate move toward to the phosphor layer; after the phosphor layer is hit by the electron, the phosphor layer emits light, which is provided to the transparent liquid crystal cell.

2. The transparent liquid crystal display device according to claim 1, wherein the transparent liquid crystal display device further comprises a controller; the transparent touch display panel, the transparent liquid crystal cell, the first transparent electrode plate, the electron-generating plate, and the second transparent electrode plate are respectively electrical connected with the controller.

3. The transparent liquid crystal display device according to claim 1, wherein a plurality of transparent electrodes are spaced apart and disposed on a surface of the electron-generating plate.

4. The transparent liquid crystal display device according to claim 1, wherein a plurality of rows of the transparent electrodes are disposed on a surface of the electron-generating plate, each row comprises a plurality of the transparent electrodes; the plurality of the transparent electrodes of each row are arranged to be evenly spaced apart from each other.

5. The transparent liquid crystal display device according to claim 4, wherein the transparent electrodes between rows are arranged to be evenly spaced apart from each other; the transparent electrodes at an (N)th row and the transparent electrodes at an (N+1)th row are disposed in a staggered position.

6. The transparent liquid crystal display device according to claim 3, wherein the transparent electrode is formed in a protuberant shape.

7. The transparent liquid crystal display device according to claim 1, wherein a plurality of comb-like electrode strips are provided on a surface of the electron-generating plate.

8. The transparent liquid crystal display device according to claim 7, wherein the comb-like electrode strip comprises a trunk and a plurality of teeth; the plurality of teeth are arranged on a side of the trunk and are evenly spaced apart from each other; the trunk of the comb-like electrode strip at an (N)th row and the trunk of the comb-like electrode strip at an (N+1)th row are arranged in parallel.

9. The transparent liquid crystal display device according to claim 8, wherein the teeth of the comb-like electrode strip at the (N)th row and the teeth of the comb-like electrode strip at the (N+1)th row are arranged in a staggered position.

10. The transparent liquid crystal display device according to claim 7, wherein the comb-like electrode strip comprises a trunk and a plurality of teeth; the plurality of teeth are arranged on a bottom side of the trunk of the comb-like electrode strip at a first row and are evenly spaced apart from each other; the plurality of teeth are arranged on a top side of the trunk of the comb-like electrode strip at a last row and are evenly spaced apart from each other; the plurality of teeth are arranged on bottom sides and top sides of the trunks of the plurality of comb-like electrode strips between the first row and the last row and are evenly spaced apart from each other; the teeth on a bottom side of the comb-like electrode strip at an (N)th row and the teeth on a top side of the comb-like electrode strip at an (N+1)th row are sequentially arranged in a staggered position.

11. A transparent liquid crystal display device, comprising a transparent liquid crystal cell and a transparent luminous plate, wherein the transparent liquid crystal cell is disposed on the transparent luminous plate;
wherein the transparent luminous plate comprises a first transparent electrode plate, a phosphor layer, an electron-generating plate, and a second transparent electrode plate; the first transparent electrode plate, the phosphor layer, and the electron-generating plate are sequentially disposed on the second transparent electrode plate;
an electron is generated after the electron-generating plate is electrified; the electron is transmitted in a random direction; an electric field E is formed after the first transparent electrode plate and the second transparent electrode plate are electrified; the electric field E induces the electron which is generated by the electron-generating plate move toward to the phosphor layer; after the phosphor layer is hit by the electron, the phosphor layer emits light, which is provided to the transparent liquid crystal cell.

12. The transparent liquid crystal display device according to claim 11, wherein the transparent liquid crystal display device further comprises a controller; the transparent liquid crystal cell, the first transparent electrode plate, the electron-generating plate, and the second transparent electrode plate are respectively electrical connected with the controller.

13. The transparent liquid crystal display device according to claim 11, wherein a plurality of transparent electrodes are spaced apart and disposed on a surface of the electron-generating plate.

14. The transparent liquid crystal display device according to claim 11, wherein a plurality of rows of the transparent electrodes are disposed on a surface of the electron-generating plate, each row comprises a plurality of the transparent electrodes; the plurality of the transparent electrodes of each row are arranged to be evenly spaced apart from each other.

15. The transparent liquid crystal display device according to claim 14, wherein the transparent electrodes between rows are arranged to be evenly spaced apart from each other; the transparent electrodes at an (N)th row and the transparent electrodes at an (N+1)th row are disposed in a staggered position.

16. The transparent liquid crystal display device according to claim 13, wherein the transparent electrode is formed in a protuberant shape.

17. The transparent liquid crystal display device according to claim 11, wherein a plurality of comb-like electrode strips are provided on a surface of the electron-generating plate.

18. The transparent liquid crystal display device according to claim 17, wherein the comb-like electrode strip comprises a trunk and a plurality of teeth; the plurality of teeth are arranged on a side of the trunk and are evenly spaced apart from each other; the trunk of the comb-like electrode strip at an (N)th row and the trunk of the comb-like electrode strip at an (N+1)th row are arranged in parallel.

19. The transparent liquid crystal display device according to claim 18, wherein the teeth of the comb-like electrode strip at the (N)th row and the teeth of the comb-like electrode strip at the (N+1)th row are arranged in a staggered position.

20. The transparent liquid crystal display device according to claim 17, wherein the comb-like electrode strip comprises a trunk and a plurality of teeth; the plurality of teeth are arranged on a bottom side of the trunk of the comb-like electrode strip at a first row and are evenly spaced apart from each other; the plurality of teeth are arranged on a top side of the trunk of the comb-like electrode strip at a last row and are evenly spaced apart from each other; the plurality of teeth are arranged on bottom sides and top sides of the trunks of the plurality of comb-like electrode strips between the first row and the last row and are evenly spaced apart from each other; the teeth on a bottom side of the comb-like electrode strip at an (N)th row and the teeth on a top side of the comb-like electrode strip at an (N+1)th row are sequentially arranged in a staggered position.
